(19) United States
(12) Patent Application Publication
(10) Pub. No.: US 2017/0297529 A1
(43) Pub. Date: Oct. 19, 2017

(54) Vehicle Computer System for Authorizing Insurance and Registration Policy

(71) Applicant: Ford Global Technologies, LLC, Dearborn, MI (US)

(72) Inventors: David Hamilton, Troy, MI (US); Andrea Bowes Chowanic, Commerce Township, MI (US); Oliver Lei, Windsor (CA)

(21) Appl. No.: 15/132,685

(22) Filed: Apr. 19, 2016

(51) Int. Cl. B60R 25/01; G06F 17/30; G06Q 40/08; H04L 29/08

(52) U.S. Cl. CPC B60R 25/01; H04L 67/306; G06F 17/30876; G06Q 40/08

(57) ABSTRACT

A vehicle computer system, comprising a processor configured to identify a driver of a vehicle utilizing driver profile data received from a driver device communicating with the vehicle, and disable driving of the vehicle in response to the driver profile data and vehicle registration data received from a remote server indicating an issue with a vehicle policy.

### TECHNICAL FIELD

The present disclosure relates to systems and methods for a vehicle computer system configured to operate with off-board servers as related to a vehicle's insurance and registration policies.

### BACKGROUND

A vehicle may be required to have valid insurance and vehicle registration information according to local law enforcement policies. A vehicle may be configured to communicate with various devices and remote servers to exchange data. Additionally, a vehicle may be able to identify a driver utilizing various driver devices.

### SUMMARY

First illustrative embodiment discloses a vehicle computer system, comprising a processor configured to identify a driver of a vehicle utilizing driver profile data received from a driver device communicating with the vehicle, and disable driving of the vehicle in response to the driver profile data and vehicle registration data received from a remote server indicating an issue with a vehicle policy.

Second illustrative embodiment discloses a vehicle computer system, comprising a processor configured to identify a driver of a vehicle utilizing driver profile data received from a driver device, and output a message at the vehicle computer system indicating a status of a vehicle insurance policy as pertaining to the driver based upon the driver profile data and vehicle policy data received from a remote server, and prevent vehicle driving in response to the status indicating an expired insurance policy or unauthorized driver.

Third illustrative embodiment discloses a server comprising a processor configured to receive from a driver device driver profile data identifying a driver in a vehicle and vehicle policy data indicating vehicle registration information, and output a status message indicating a vehicle driver policy at a vehicle computer system of the vehicle utilizing the driver profile data and vehicle policy data.

### BRIEF DESCRIPTION OF THE DRAWINGS

FIG. 1 is an illustrative block topology for a vehicle computer system (VCS) for a vehicle;

FIG. 2 is an illustrative block topology of a vehicle interacting with the cloud and web server;

FIG. 3 is a flowchart illustrating the vehicle computer system verifying driver registration information.

FIG. 4 is a flowchart illustrating a vehicle server verifying driver registration information.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

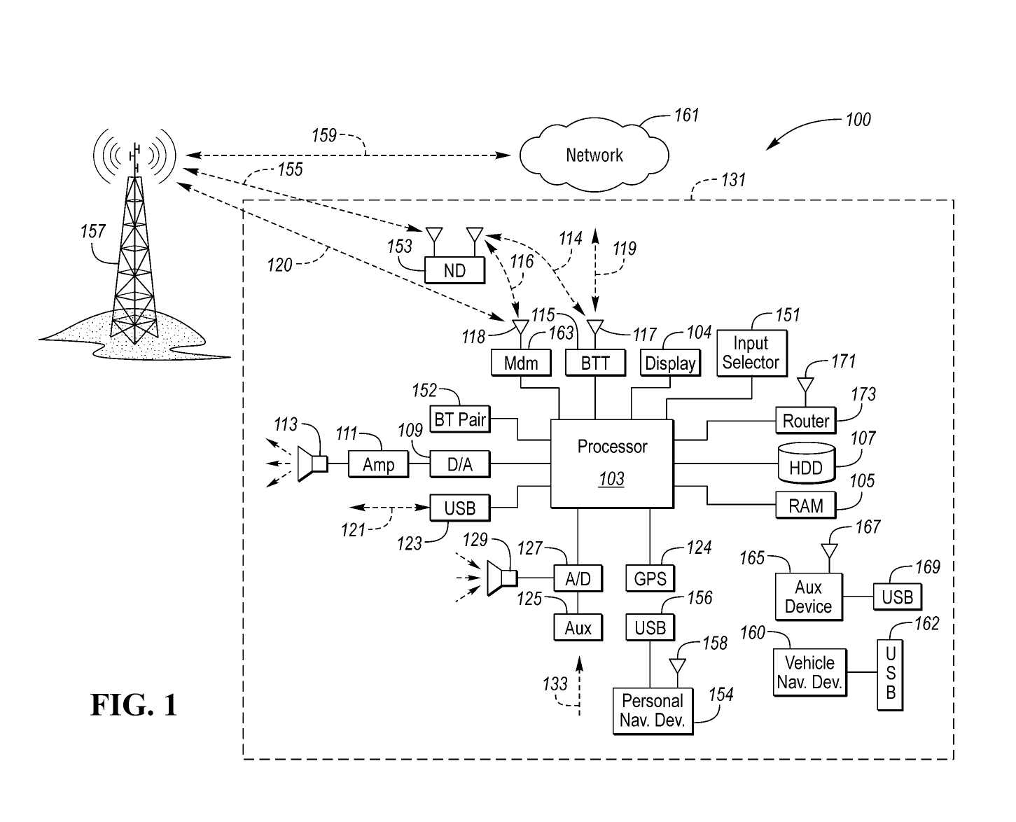

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

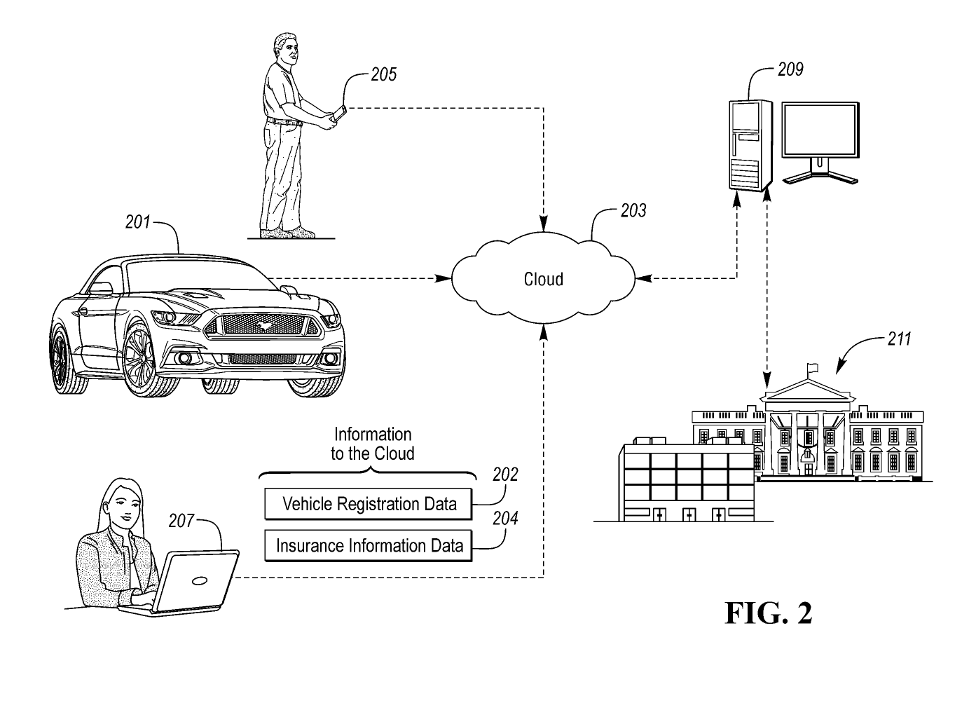

FIG. 2 is an illustrative block topology of a vehicle interacting with the cloud and web server. A vehicle 201 may include an interface to interact with a user to provide functionality. The vehicle 201 may be utilized to maintain driver registration and insurance records of the various drivers in the vehicle. The vehicle may utilize a user's mobile phone or key fob to understand which user is exactly driving the vehicle. The mobile phone may be associated with a driver and send driver recognition data to the VCS identifying the user during the pairing process. The vehicle's key fob may also be associated with a driver and send driver recognition data to the VCS upon entering the vehicle or turning on the ignition. The VCS may determine which driver is currently in the vehicle to compare insurance and registration information.

The VCS of the vehicle may allow the driver to input insurance and registration information via an interface of the VCS. For example, the VCS may include a graphical interface requesting information from the driver, such as name, address, registration number, license number, insurance information (e.g. provider, policy number, registration date, expiration date, authorized drivers, vehicle identification number (VIN), etc.), and other information. The VCS may store this information locally on either non-persistent 5 or persistent storage 7, including a HDD or USB drive. The VCS may also interact with the “cloud” 203, or any other type of network of servers that may be utilized for different functions and services, to store that information. The VCS may send vehicle registration information or insurance information to the cloud utilizing an embedded telematics unit or an in-vehicle mobile phone that is in communication (e.g. utilizing Bluetooth) with the VCS.

The vehicle registration 202 and insurance information 204 may also be sent to the cloud via a mobile device 205. The mobile device 205 may include an application to support the entering of vehicle registration data 202 or insurance information data 204, or may utilize a website to enter such application. Additionally, the mobile phone 205 may be utilized to take a picture of the vehicle registration and insurance information to send to the cloud 203. The cloud 203 may analyze the pictures to extract the vehicle registration data 202 and the insurance information data 204. The mobile device 205 may also work in conjunction with a vehicle 201 equipped with a VCS to send the vehicle registration data 202 and the insurance information data 204 to the cloud 203.

The vehicle registration 202 and insurance information 204 may also be sent to the cloud via a web portal 207. The web portal 207 may be an application to support the entering of vehicle registration data 202 or insurance information data 204, or may simply be a website to enter such information. The web portal 207 may require that the user identify themselves and their vehicle by requiring a login account and entering a vehicle identification number (VIN). The web portal 207 may send vehicle registration data 202, insurance information data 204, or any other driver identification data or vehicle identification data to the cloud 203.

The cloud 203 may also be in communication with a vehicle server 209, such as a FORD MOTOR COMPANY cloud server. The vehicle server 209 may be able to connect to a government server or insurance server 211 to determine relevant actions needed to maintain the user's account for insurance and vehicle registration. The vehicle server 209 may utilize the cloud 203 to communicate data from the government or insurance agency 211 to the vehicle 201. The vehicle server 209 may determine when the user must register the vehicle or renew insurance based on data communicated by the government or insurance company 211. The vehicle server 209 may inform the vehicle when action is needed related to the policies (e.g. renewal) via alerts during a pre-defined time period (e.g. 7 days, 1 month, etc.) before such action is required (e.g. registration or insurance policies expire). Additionally, other vehicle data may be sent form the vehicle 201 to the vehicle server 209, including vehicle data indicative of the vehicle's environment (e.g. GPS data, vehicle speed, acceleration data, gyroscope data, navigation data, route data, etc.).

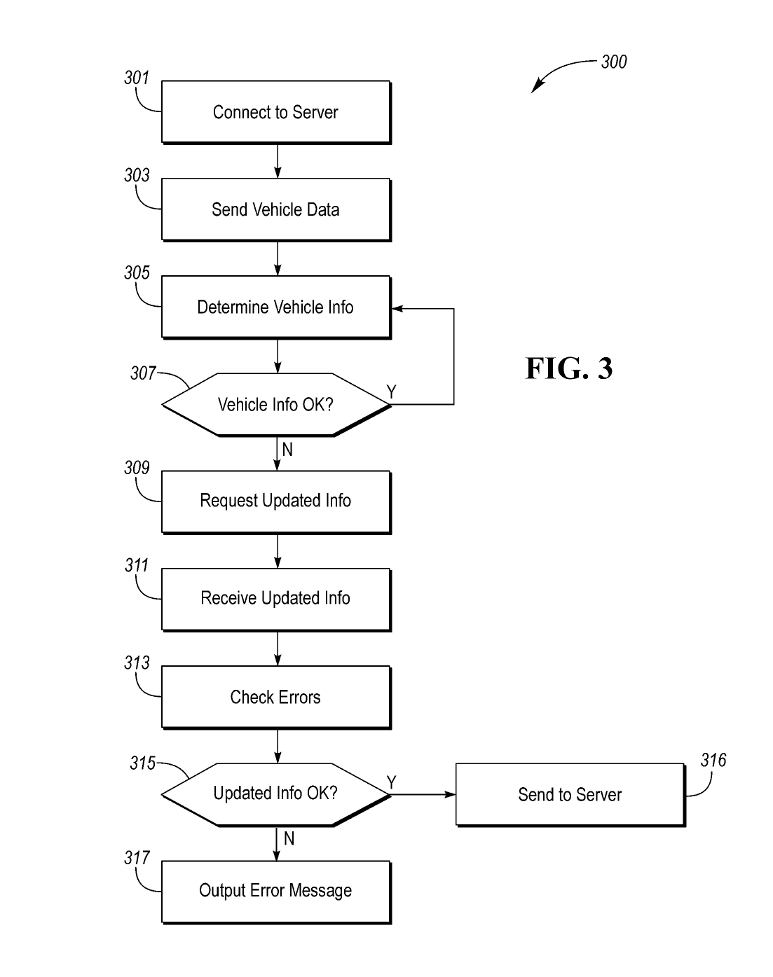

FIG. 3 is a flowchart illustrating the vehicle computer system verifying driver registration information. A vehicle computer system (VCS), such as disclosed in FIG. 1, may connect to a server 301 utilizing a mobile phone or an embedded telematics system. By connecting to the server, the vehicle may exchange and communicate data to various off-board servers. The servers may be utilized to gather and process data. The server may also send to the vehicle or server data or requests for actions to be performed at the other servers, vehicles, or devices. It should be recognized that the descriptions of processes occurring at the server may also be done by VCS.

The VCS may send vehicle data 303 to the server to assist the user in the vehicle registration and insurance policy. The VCS may send the vehicle registration data 202 and insurance information data 204 to the server based on the user inputting the required data into the VCS. In another embodiment the user may input the vehicle registration data 202 and insurance information data 204 into a mobile device 205, which may connect to the VCS and then send to the server. Other embodiments may send the registration data 202 and insurance data 204 without using the VCS, such as simply through using a web portal 207 or the mobile device 205 by itself. The cloud 203 or vehicle server 209 may utilize the registration data 202 and insurance data 204 to determine if the policies need to be renewed or alerts to the driver are needed. The VCS or vehicle server 209 may have determined pre-defined times prior to policy expirations to notify a user. The server may send requests for the vehicle to output such alerts, or the server send data to the vehicle recognizing that the policy is not within a pre-defined period for alerting a user. In addition, the cloud 203 or vehicle server 209 may send and communicate requests or data back to the VCS for processing in some embodiments.

The VCS may analyze data received from the cloud to determine if the vehicle information is appropriate 305. For example, the vehicle server 209 may send data to the vehicle recognizing that no action needs to be taken. In another example, the vehicle server 209 may send a request to the VCS to output a message notifying the user that the insurance policy may expire by a certain date, thus requiring action to be taken (e.g. including payment of the insurance policy or vehicle registration utilizing the VCS). The VCS itself may also analyze data communicated by the vehicle server 209 or cloud 203 to determine the status of the vehicle information and policies. The VCS may utilize the data to determine all data is okay 307 and no action is required based on the vehicle registration data 202 or insurance information data 204. If it is determined that the data is okay, the VCS may simply continue to monitor such data, either by itself or in conjunction with off-board servers.

The VCS may also connect to other devices to utilize data received from the device to determine information derived from the device. The vehicle may utilize a driver's smart watch, mobile phone, or key fob to connect and receive data indicating the driver. The driver device may be associated with a driver and send driver profile data to the VCS to help identify the driver. The vehicle's key fob may also be associated with a driver and send driver profile data to the VCS upon entering the vehicle or turning on the ignition. The VCS may determine which driver is currently in the vehicle to compare insurance and registration information. Thus, the VCS may be able to not only ensure a policy is valid for the vehicle that the policy pertains to the current driver utilizing the vehicle.

If it is determined that the vehicle registration data 202 or insurance information data 204 is outdated, expired, or contains other issues, the VCS may request updated information 309 from the user via an interface. In one example, the vehicle may output a message identifying an error or issue and request that the user add, verify, or modify information related to the vehicle registration data 202 or insurance information 204. The user may then input such requested information via an interface of the VCS, or utilizing the mobile phone 205 or a web portal 207. The VCS may receive such updated information 311, to which it may forward to the cloud 203 or vehicle server 209.

The VCS may then again check for errors or issues 313 with the vehicle information. The VCS may process the new data itself to determine if such errors or issues are correct. For example, the VCS may determine that an expired policy is being used, and require that the user input a new policy with an appropriate expiration date. The VCS may compare the current date with the policy expiration date to determine if the policy is valid. When the VCS determine that the vehicle policy is not valid, it may prevent the driver from using or driving the vehicle. The VCS may send messages to various vehicle controllers via the vehicle's communication bus requesting that the vehicle cannot be operated until any issues with the vehicle policy are resolved. Furthermore, the VCS may also send messages to the vehicle controllers via the vehicle's communication bus requesting that the vehicle can be operated if the issues are resolved with the vehicle policy. For example, the VCS may send a message to the vehicle's engine control module (ECM) notifying the ECM that the engine should not be initiated or cease operation. Additionally, the ECM may also notify the ECM that the engine operation could continue operation or become activated if the vehicle policy is determined valid or any issue is resolved with respect to the vehicle policy.

In another embodiment, the VCS may utilize the server to communicate data for processing. The server may utilize the updated data received from the VCS, as well as from other servers, insurance server or government server 211 to determine if any error exits. The server may additionally use data communicated directly from a web portal 207 or smartphone 205 to determine if any errors still exits based on the updated data.

The VCS may then determine if the updated information is appropriate 315 as pertaining to the vehicle's policy. The VCS may make the determination itself utilizing the vehicle policy data, or the VCS may send the updated info to the server 316. If it is determined that the vehicle registration policy or insurance policy includes errors, the VCS may output an error message 317, or a status message. The message may indicate what issues are related to the registration or insurance policy, for example. In another example, the error message that is output 317 may indicate that the driver currently utilizing the vehicle is not appropriate to be using the vehicle. For example, a user's insurance policy may not include coverage for the driver identified that is currently operating the vehicle. The VCS may also be able to output other messages or information related to the vehicle policy. For example, the VCS may include an interface that includes an input button to activate a “quick access” button for insurance or registration information. Thus, in a scenario that the driver needs to access this information, for example if the driver is pulled over, the driver may utilize an interface of the VCS (e.g. voice recognition or touch screen) to output a screen to show the relevant information for the vehicle registration.

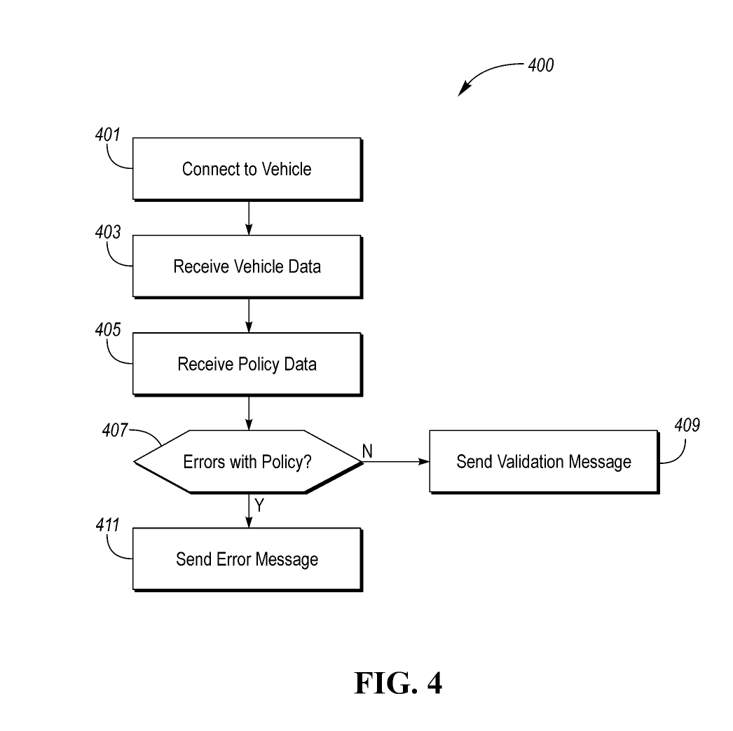

FIG. 4 is a flowchart illustrating a vehicle server verifying driver registration information. The vehicle server may affiliate with a manufacturer of the vehicle, or may be another type of server that includes access to relevant databases (stored at the server or remotely) for verifying vehicle policies. The server may be connected to a vehicle 401 either directly or through the “cloud” in order to communicate data between the server and vehicle. The server may be in communication with only vehicles of the same manufacturer, while in other embodiments, the server may be in communication with vehicles of different manufacturer.

The server may receive vehicle data 403 upon establishing a connection. The server may also be able to send data to the vehicle that is stored remotely or accessed off-board. The server may request vehicle data related to various vehicle policies, including insurance information, registration information, driver profile data, and other vehicle data (e.g. VIN, data from sensors, etc.)

The server may also receive policy data 405 from another remote server. Additionally, the server may receive other data from servers that may facilitate in the determination of the status of the vehicle's insurance and registration policy. For example, the server may receive insurance data from an insurance agency or insurance server that stores vehicle insurance data indicating a vehicle's insurance policy information. In another example, the server may receive vehicle registration data from another server, such as a government server (e.g. Secretary of State or Department of Motor Vehicle) that maintains a database of data related to vehicle registration or other policies. In yet another example, the server may communicate with a government agency or government server to receive data related to laws and regulations (e.g. state laws or local regulations) pertaining to vehicle policy of a current area of the vehicle.

The server may analyze the data receive from other vehicles and servers and determine if there is an error with any vehicle policies 407. The server may, for example, utilize vehicle registration data and vehicle insurance data, coupled with driver profile data received from the vehicle, to determine if an authorized driver is utilizing the vehicle. In another example, the server may determine if the vehicle registration is expired utilizing the vehicle registration data and other data. For example, the server may extract the expiration date of a vehicle policy and compare it to the current data to determine if the vehicle policy has expired. In yet another example, the server may determine if the vehicle insurance policy is expired utilizing the vehicle insurance data and other data. If the server determines that the vehicle policy is valid, the server may send a validation message to the vehicle 409. If the server determines that there are errors or issues with the vehicle policy, the server may send an error message to the vehicle indicating such issue 411. The server may send a request to the vehicle to disable driving or lock-out the vehicle based upon the server detecting a vehicle policy. The request may include a message to prevent driving of the vehicle that is received at various vehicle controllers. Additionally, the request may also include a message to cease prevention of driving the vehicle and to allow the driver of the vehicle to drive the vehicle. For example, the server may send a message to the vehicle's ECM to allow operation of the vehicle if the vehicle policy is valid.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle computer system, comprising:
a processor configured to identify a driver of a vehicle utilizing driver profile data received from a driver device communicating with the vehicle, and disable driving of the vehicle in response to the driver profile data and vehicle registration data received from a remote server indicating an issue with a vehicle policy.

2. The vehicle computer system of claim 1, wherein the processor is further configured to output the issue for display.

3. The vehicle computer system of claim 1, wherein the processor is further configured to output an error message for display indicating a request for additional information as related to the vehicle policy.

4. The vehicle computer system of claim 1, wherein the issue is an unauthorized driver of the vehicle utilizing the driver profile data and vehicle registration data.

5. The vehicle computer system of claim 1, wherein the processor is further configured to disable driving of the vehicle in response to vehicle insurance data received from a remote server.

6. A vehicle computer system, comprising:
a processor configured to identify a driver of a vehicle utilizing driver profile data received from a driver device, and output a message at the vehicle computer system indicating a status of a vehicle insurance policy as pertaining to the driver based upon the driver profile data and vehicle policy data received from a remote server, and prevent vehicle driving in response to the status indicating an expired insurance policy or unauthorized driver.

7. The vehicle computer system of claim 6, wherein the processor is further configured to lock-out or deactivate a vehicle controller when the status of the vehicle insurance policy indicates an expired insurance policy or unauthorized driver.

8. The vehicle computer system of claim 6, wherein the processor is further configured to send the driver profile data to the server to determine an authorized driver is operating the vehicle utilizing the vehicle policy data and the driver profile data.

9. The vehicle computer system of claim 6, wherein the driver device is received from at least one of a mobile phone, smart watch, or a key-fob.

10. The vehicle computer system of claim 6, wherein the processor is further configured to output directions to a point-of-interest in response to the status of the vehicle policy.

11. The vehicle computer system of claim 10, wherein the point-of-interest is a vehicle registration agency when the status of the vehicle policy indicates an issue.

12. The vehicle computer system of claim 6, wherein the vehicle policy data includes vehicle insurance data or vehicle registration data.

13. The vehicle computer system of claim 6, wherein the processor is further configured to receive input of vehicle policy information utilizing an interface of the vehicle computer system.

14. The vehicle computer system of claim 6, wherein the processor is further configured to send the driver profile data to the remote server.

15. A server comprising:
a processor configured to receive from a driver device driver profile data identifying a driver in a vehicle and vehicle policy data indicating vehicle registration information, and output a status message indicating a vehicle driver policy at a vehicle computer system of the vehicle utilizing the driver profile data and vehicle policy data.

16. The server of claim 15, wherein the status message indicates that the vehicle driver policy includes issues based upon the driver.

17. The server of claim 15, wherein the status message indicates the vehicle driver policy is valid based upon the driver.

18. The server of claim 15, wherein the server is configured to communicate with vehicles of only a same manufacturer.

19. The server of claim 15, wherein the processor is further configured to receive insurance policy data from at least one of a vehicle server or an insurance server.

20. The server of claim 15, wherein the processor is further configured to receive vehicle registration data from at least one of a vehicle server or a government server.
